(19) United States
(12) Patent Application Publication
(10) Pub. No.: US 2016/0362347 A1
(43) Pub. Date: Dec. 15, 2016

(54) HYDROTHERMAL LIQUEFACTION PROCESS

(71) Applicant: Alireza Shekarriz, Rio Rancho, NM (US)

(72) Inventor: Alireza Shekarriz, Rio Rancho, NM (US)

(21) Appl. No.: 15/177,671

(22) Filed: Jun. 9, 2016

Related U.S. Application Data
(60) Provisional application No. 62/173,812, filed on Jun. 10, 2015.

(51) Int. Cl. C07B 61/00; C10G 1/00

(52) U.S. Cl. CPC C07B 61/00; C10G 1/008; C10G 2300/1014; C10G 2300/1018; C10G 2300/1003

(57) ABSTRACT

Hydrothermal liquefaction is performed on organic feedstocks. The feedstock is first subjected to hydrothermal carbonization conditions, which converts all or a portion of the feedstock to a carbonized solid. The carbonized solid is then reduced in particle size, and the reduced size carbonized particles including the remainder of the products of hydrothermal carbonization are then subjected to hydrothermal liquefaction.

This invention relates to a hydrothermal liquefaction process for converting organic matter to one or more liquid hydrothermal liquefaction products.

Hydrothermal liquefaction is a method by which an organic feedstock is converted to lower molecular weight carbonaceous compounds that are room temperature liquids. Hydrothermal liquefaction allows feedstocks to be converted to higher-value liquid conversion products. The liquefaction products include oils and low molecular weight liquid organic compounds that, depending on their precise nature, find value as chemical feedstocks and in other potential applications.

The economics of the process depend heavily on the ability to process inexpensive feedstocks. The organic feedstock generally (but not always) is a biological material of one kind or another, and for that reason typically contains a complex mixture of chemicals and polymers. A typical organic feedstock is or includes one or more biological waste products such as plant waste products, animal (including human) waste products, agricultural and slaughterhouse wastes, food wastes and other industrial and materials processing wastes that have little if any economical value in their existing form. The ability to process waste materials has the additional benefit of reducing the problem of disposing with those wastes.

Many of these waste feedstocks include or consist of solids. To process these efficiently and obtain a uniform and predictable product, it is necessary to provide the solid feedstock in the form of small particles. Unfortunately, the waste materials used as feedstocks seldom are obtained in a conveniently formatted particle size distribution. Plant wastes, for example, may consist of stalks, branches, leaves, stripped bark or large chips. In these cases, it is necessary to reduce these to micron- and nano-sized particulate form before they can be processed through the hydrothermal liquefaction process. The problem is exacerbated in many cases because organic materials such as plant wastes often are tough, non-friable materials that are difficult to grind. Therefore, the size reduction steps add very substantial equipment and operating costs to the process, and severely reduce its overall economic viability.

What is desired is an economical and method by which solid organic waste materials can be converted to hydrothermal liquefaction products.

This invention is a hydrothermal liquefaction process comprising the steps of

a) combining a particulate solid organic feedstock with water to form an aqueous slurry;

b) subjecting the slurry to hydrothermal carbonization conditions including a temperature of at least 160° C. and a superatmospheric pressure sufficient to maintain water as a subcooled liquid, to at least partially carbonize the feedstock and form at least partially carbonized solids, then

c) reducing the size of the at least partially carbonized solids to produce reduced-size carbonized particles; and

d) subjecting the reduced-size carbonized particles to hydrothermal liquefaction conditions in the presence of subcooled water, steam or a mixture of subcooled water and steam to convert at least a portion of the reduced-size carbonized particles to one or more liquid hydrothermal liquefaction products.

This process has several important advantages. The hydrothermal carbonization step b) is relatively tolerant of large-size feedstocks; therefore it is not necessary to provide an initial feedstock that has a particle size small enough for efficient hydrothermal liquefaction. Instead, the feedstock in this process may include coarse particles or even large pieces.

During the hydrothermal carbonization step, some or all of the feedstock is converted to particles that are at least partially carbonized. The carbonized material is quite friable, and so the step of reducing the size of the particles can be accomplished quickly and inexpensively.

In some cases, larger pieces of the feedstock may not become fully carbonized in the hydrothermal carbonization step—they may have carbonized exterior and interior portions that have not reacted or reacted only partially during the hydrothermal carbonization step. The size reduction step may include stripping the carbonized surfaces from those larger pieces, in some instances leaving a core of unreacted or partially reacted material that can be separated if necessary. If desired, the separated unreacted or partially reacted material can be re-processed through the hydrothermal carbonization step to carbonize it further.

Yet another advantage of the process is that it can be adapted easily for continuous or semi-continuous operation.

In some embodiments, the hydrothermal carbonization, size reduction and hydrothermal liquefaction steps are performed in simplified equipment, which leads to substantial savings in capital investment and operating costs.

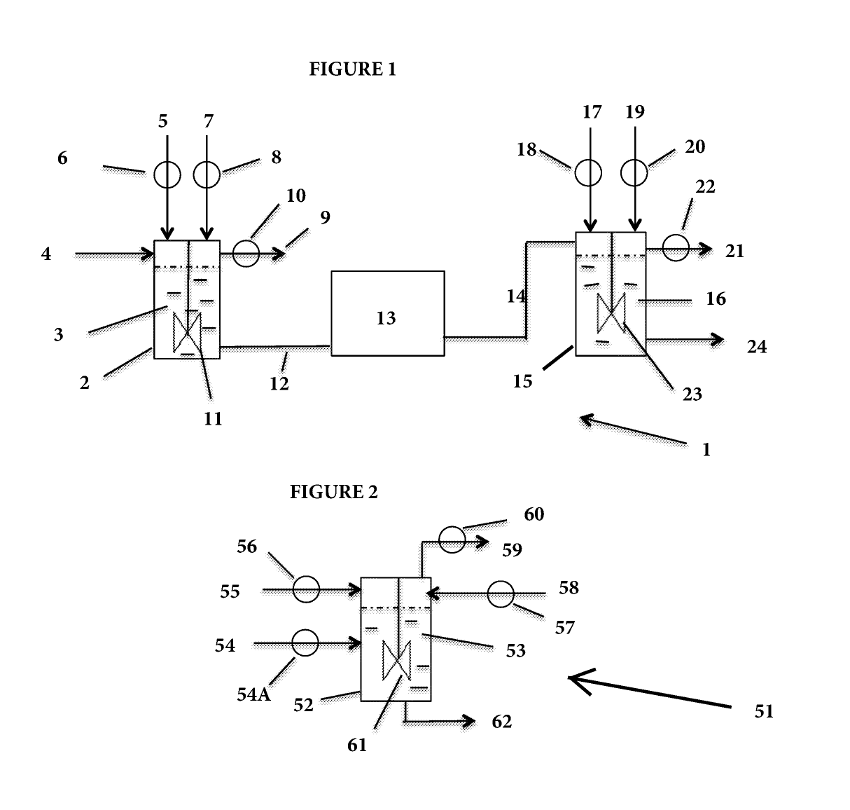

FIG. 1 is a schematic diagram of an embodiment of an apparatus for performing the process of the invention.

FIG. 2 is a schematic diagram of a second embodiment of an apparatus for performing the process of the invention.

The organic feedstock used in this invention includes an organic material that is solid at the temperature of the process. At least a portion of the solid organic material (prior to conversion) should be insoluble in water at the temperature of the hydrothermal carbonization step. The organic feedstock may contain, in addition to the solid organic material, one or more organic materials that have melting temperatures below the process temperature and/or which are soluble in water at the temperature of the hydrothermal carbonization step.

The feedstock includes one or more organic compounds having at least one C—H bond, and which more typically also include at least one carbon-oxygen bond and/or at least one carbon-nitrogen bond. The organic compounds may contain other types of bonds, such as (without limitation) one or more carbon-halogen bonds, one or more carbon-phosphorus bonds, one or more carbon-sulfur bonds, one or more oxygen-hydrogen bonds, one or more nitrogen-hydrogen bonds, as well as others. The solid organic feedstock preferably has an oxygen:carbon atomic ratio of at least 0.5 and a hydrogen:carbon atomic ratio of at least 1.5, preferably at least 1.75.

Some or all of the organic compounds may be of biological origin i.e., one or more materials produced by biological processes. All or some of the organic materials may have been pretreated thermally (e.g., by autoclaving), thermochemically (e.g., by aerobic or anaerobic digestion), mechanically (e.g., by dry grinding, wet grinding, sorting, filtration, etc.), or chemically (e.g., by flocculation). Organic materials of biological origin include plant tissues, i.e., whole plants as well as parts of plants such as stems, leaves, seeds, seed pods or other fruit, flowers and roots; and cellulosic or lignocellulosic plant products such as cellulose, cotton, linen, other plant fibers, wood, and the like. Such plant tissues may include, for example, various stover products (where “stover” refers to plant residue of annual plants that remains after harvest or otherwise at the end of the growing season), straw, hay, leaves, branches, trunks and/or roots of trees, and the like. The plant matter may include plant products such as paper, rope and other fibrous products, cardboard, wood, wood particles (including sawdust) and other waste from sawmill operations, waste wood and waste wood products, or other lignocellulosic material of plant origin.

Another type of organic material of biological origin is animal tissue such as animal cadavers and animal parts such as muscles, skin, hair, internal organs, connective tissue and the like. Animal tissues also include animal products such as, for example, leather, hair, wool and the like.

Other types of organic material or biological origin include microbial biomass such as bacteria, yeast, algae and other microbes, which may be living or dead.

Yet other types of organic material of biological origin include animal feces (which may include human feces), which feces may have been previously treated through a pretreatment process such as a digestion, composting, autoclaving, or fermentation process. Feces (whether pretreated or not) typically contains microbial material, which typically includes bacteria or other microbes such as are present in the gut of the animal that produced the feces. The microbial material may include microbes that are added to the fecal matter in a pretreatment step, such as an aerobic or anaerobic digestion or fermentation pretreatment. The microbial material may include live cells, dead cells or both. Feces also typically include undigested plant or animal tissue (such as fiber), fat, and/or protein in addition to the microbial material.

The organic feedstock may include a sludge produced in the microbial digestion of fecal matter (optionally together with other organic feedstocks such as garbage and/or plant or animal tissues) by microbial action. The organic matter may be a blend of this sludge and one or more other types organic matter.

Organic matter of biological origin can take the form of wastes from various processing operations, such as wastes from agricultural harvesting and processing, slaughterhouse, butchery or other meat-processing wastes; household and other garbage and/or rubbish; wastes from food-processing operations (for human and/or animal consumption, or in the production of fertilizers), wastes from restaurants or groceries, and the like.

In addition to the foregoing feedstock materials, industrial wastes and by-products and recovered materials including various types of polymeric materials are useful. For example, polymeric scrap or trim from various types of thermoplastic and/or thermosetting polymer processing operations can be used, as well as recycled post-industrial or post-consumer thermoplastic and/or thermoset polymers.

An advantage of the invention is that the solid feedstock does not need to be finely divided before the start of the process. It is generally sufficient to size the feedstock so it fits in the processing equipment and can be processed in or through it. The feedstock may, for example, contain individual pieces or particles that have volumes of 1 mL or larger, which are difficult to process efficiently in a conventional hydrothermal liquefaction process. The feedstock may contain individual pieces or particles that have volumes of at least 2 mL, at least 5 mL, at least 10 mL, at least 25 mL, at least 50 mL or at least 100 mL. The upper limit on the size of the individual pieces is limited only by the ability to handle them in the particular processing equipment. Pieces of these sizes may constitute, for example, at least 1%, at least 2%, at least 5%, at least 10%, at least 25%, at least 50% of the total weight of the solid organic feedstock.

More finely divided feedstocks can be used. Many waste feedstocks contain a mixture of finely divided matter and more coarsely divided material. In the case of waste plant matter, for example, finely divided material is often mixed in with larger pieces of stalks or branches or even large leaves. Such a mixture is a suitable starting material for this process. Similarly, municipal and industrial wastes, fecal matter and other waste materials that contain both large and small sized particles are useful. If desired, larger pieces of the feedstock material can be coarsely divided to form pieces or particles having volumes, for example, of 0.25 to 10 mL.

The organic feedstock is combined with water to form a slurry, and the slurry is subjected to hydrothermal carbonization conditions. The hydrothermal carbonization conditions are sufficient to convert at least a portion of the organic feedstock to at least partially carbonized solid particles. The hydrothermal carbonization conditions include a temperature of at least 160° C. and a superatmospheric pressure sufficient to maintain the water as a subcooled liquid, i.e., above the saturation pressure of water at the operating temperature.

The solids content of the starting slurry can vary widely from, for example, a solid content as low as 0.1% by weight, to as high as 30% by weight. Preferred solids contents are 1 to 10%, 1 to 8% or 1 to 5% by weight.

The aqueous phase of the slurry includes water, which may have various materials dissolved therein. The dissolved materials may include, for example, inorganic salts, water-soluble organic materials including water-soluble biological materials such as proteins, sugars, saccharide oligomers, and the like; surfactants and/or flocculants; and the like. These dissolved materials may be brought into the slurry with the feedstock or may result from dissolution and/or reaction of the feedstock. Preferably, undissolved material other than the organic feedstock (i.e., which does not form part of the organic feedstock) constitutes no more than 5%, more preferably no more than 1% of the weight of the slurry. Water preferably constitutes at least 35%, more preferably at least 50%, of the total weight of the slurry at the start of the hydrothermal carbonization reaction.

The reaction mixture as described above is brought to a temperature of at least 160° C. and sufficient pressure to maintain water as a subcooled liquid, and maintained under those conditions for a period of time sufficient to at least partially carbonize the feedstock to form at least partially carbonized solids. The temperature preferably is less than 300° C. and more preferably no more than 250° C. in this step. The pressure may be up to 8 MPa, more preferably 0.62 to 8 MPa and still more preferably 1 to 7 MPa.

The hydrothermal carbonization reaction is typically exothermic. Therefore, once reaction conditions are achieved, it is in most cases not necessary to apply additional heat to maintain the reaction temperature and to the contrary may be necessary to apply cooling to remove exothermic heat from the reaction mixture. Exothermic heat can be captured and used in other useful ways. As an example, this recovered heat may be captured in a counterflow heat exchanger, where the high pressure and high temperature side are the reactor lines, to convert water flowing at lower pressures to steam, and the steam generated in this process can be used to produce mechanical power or to drive a steam generator to produce electric power.

The equipment used to perform the first hydrothermal carbonization step is not critical, so long as it can tolerate the necessary temperatures and pressures. Batch, semi-batch, semi-continuous or continuous equipment can be used depending in part on the physical form (including particle size) of the feedstock.

In addition, methods and equipment for performing hydrothermal carbonization of an organic feedstock to a carbonized solid such as described in, for example, Kruse et al., Current Opinion in Chemical Biology 2013, 17:515-521; US Published Patent Application No. 2008-0006518; US Published Patent Application No. 2012-0000120; WO2012/095408; and US Published Patent Application No. 2012-0110896 are suitable for performing the hydrothermal carbonization step of this invention.

The hydrothermal carbonization step may be performed using a method as described in US Published Patent Application No. 2015-0361372 (incorporated herein by reference). In such a process, the aqueous feedstock slurry is mixed under elevated pressure with a steam stream under conditions such that upon mixing all or a portion of the steam condenses and a reaction mixture having a temperature of at least 160° C. is formed at a pressure such that water including the condensed steam remains as a subcooled liquid. The reaction mixture is maintained at a temperature of at least 160° C. and at a temperature sufficient to maintain water including the condensed steam as a subcooled liquid for a period of time sufficient to produce at least partially carbonize the feedstock.

The carbonized material produced in the hydrothermal conversion step in some embodiments is characterized by having an oxygen:carbon atomic ratio of <0.4, <0.3, <0.2, <0.1 or <0.05, a nitrogen:carbon atomic ratio of <0.2, <0.1, <0.05 or <0.025, and/or a hydrogen:carbon atomic ratio of <1.5, <1.2, <1.0 or <0.8.

The particle size of the at least partially carbonized feedstock is then reduced. Preferably, the size of the at least partially carbonized solids is reduced such that carbonized particles form having surface areas of 3.2 cm² or less (which corresponds to spherical particles approximately 1 cm in diameter). More preferably, the particle size is reduced so that carbonized particles are produced that have surface areas of 0.03 cm² or less (which corresponds to spherical particles approximately 1 mm in diameter). The surface area of the carbonized particles may be significantly smaller than that, for example, 0.01 cm² or less, 0.001 cm² or less, 0.0001 cm² or less, and as small as, for example, 0.00000001 cm². It may not be necessary to reduce the size of small carbonized particles produced in the first hydrothermal carbonization step.

An advantage of this invention is that carbonized material formed in the first hydrothermal carbonization step is friable. Therefore the energy requirements to reduce the particle size of the carbonized material are small compared to those needed to reduce the particle size of the starting organic feedstock. Size reduction after the hydrothermal carbonization step is accomplished much more easily, at generally lower cost, than doing so to the starting organic feedstock. In addition, very small particle sizes are significantly easier to obtain from the carbonized material produced in the hydrothermal carbonization step.

Individual pieces of the original feedstock may not be entirely carbonized during the hydrothermal carbonization step. Such pieces may, for example, be carbonized at their exposed surfaces, leaving an interior portion that is incompletely carbonized or not carbonized at all. In the size reduction step, the carbonized surface may be removed, leaving the uncarbonized or partially carbonized interior, which may be larger than wanted for the subsequent liquefaction step. In such a case, the larger pieces, including any such uncarbonized or partially carbonized interiors from which a carbonized surface has been removed, can if desired be separated from the reduced-size carbonized materials before taking the carbonized material to the hydrothermal liquefaction step. Uncarbonized or partially carbonized particles, if small enough, can be sent to the hydrothermal liquefaction step together with the reduced-size carbonized particles. Alternatively, the uncarbonized or partially carbonized particles can be returned to the hydrothermal carbonization step for further carbonization.

The step of separating the reduced-size carbonized particles can be performed using any convenient method for separating solids on the basis of size, including sieving, filtering, centrifuging and the like. The density of the carbonized particles tends to be greater than that of the liquid phase and that of the organic feedstock. Accordingly, those carbonized particles often settle easily from the reaction mixture. This property also can form the basis for a separation step, by, for example, allowing the reduced-size carbonized particles to settle and removing them from the bottom of the reaction vessel.

The size reduction step can be performed mechanically, such as by grinding, cutting and/or chopping, using any suitable apparatus. Depending on the particular method used, it may be necessary to partially or completely separate the carbonized solids from the liquid phase before performing a mechanical size reduction step. A rotor-stator type device is a useful apparatus for reducing particle size, as such devices are adapted to handle particle slurries, so the need to dewater the solids is reduced or eliminated.

The size reduction step may be performed entirely or in part using cavitation-induced size reduction methods. In such a method, the partially carbonized solids are suspended in a liquid, which preferably includes water. Small voids or bubbles are formed in the liquid and then caused to collapse. The collapse of the voids or bubbles supplies the energy for the size reduction step.

The voids or bubbles can be produced mechanically by the operation of a rapidly spinning rotor. The rotor produces localized voids that collapse as they become transported away from the immediate vicinity of the rotor.

Alternatively, the voids or bubbles can be produced and collapsed through manipulation of pressure and/or temperature conditions. In such a method, a slurry of the carbonized particles and a liquid is formed. Conditions are such that at least a portion of the liquid phase is subcooled. The temperature may be slightly below (such as within 20° C., preferably within 10° C. and more preferably within 5° C.) of the boiling temperature of the liquid at the process pressure. The subcooled liquid is then brought to pressure and temperature conditions such that a portion of it volatilizes to form bubbles in the liquid phase. The solids may function as bubble nucleation sites. This can be performed by i) decreasing the pressure, ii) increasing the temperature, or iii) some combination of reducing pressure and increasing temperature. Reducing the pressure has the advantages of requiring minimal if any energy input and of allowing very rapid transition from subcooled to boiling conditions. By manipulating pressure, bubble formation often can be achieved in less than one minute, or even less than 10 seconds, or in some instances in less than 1 second. Once bubbles are formed, they are collapsed by again adjusting the pressure and/or temperature conditions to subcooled conditions. This can be performed by i) increasing the pressure, ii) decreasing the temperature, or iii) some combination of increasing pressure and decreasing temperature. As before, changing the pressure is particularly advantageous, as bubble collapse can be achieved, for example, in less than one minute or even less than 10 seconds, or in some instances in less than 1 second. This allows rapid cycling between bubble formation and bubble collapse.

A preferred cavitation-induced size reduction step therefore includes cycling a slurry of the at least partially carbonized product of the hydrothermal carbonization step through one or more bubble forming and bubble collapsing cycles whereby the at least partially carbonized solids are reduced in size, wherein each bubble forming and bubble collapsing cycle includes the steps of, i) adjusting the pressure and/or temperature of the intermediate slurry such that a portion of the liquid phase volatilizes to form bubbles and then ii) re-adjusting the pressure and/or temperature to collapse the bubbles. The number of cycles may be as few as one, or any arbitrarily larger number as may be needed to achieve the desired particle size reduction. For example, up to 10,000,000, up to 1,000,000, up to 100,000, up to 25,000, up to 10,000, up to 1,000, up to 100, up to 25 or up to 10 bubble forming and bubble collapsing cycles can be performed. The cycle time, expressed as number of bubble forming and bubble collapsing cycles per unit time, may range for example from 0.01 to 100,000 cycles per second.

The liquid phase in any such cavitation-induced size reduction process preferably includes water, and the bubbles may be wholly or partially formed from water that volatilizes during the bubble forming step. The liquid during such a cavitation-induced size reduction process can be or include the same aqueous liquid phase as is present during the hydrothermal carbonization step. In such a case, it is not necessary to separate the carbonized particles from the process liquor. Instead, the entire slurry can be taken to the cavitation-induced size reduction step. In such cases, the cavitation-induced size reduction step can be performed if desired in the same equipment as the hydrothermal carbonization step and/or the hydrothermal liquefaction step. The cavitation-induced size reduction step in those cases can be performed during the hydrothermal carbonization step, and/or afterward, such as during the hydrothermal liquefaction step. Often, the process liquor formed during the hydrothermal carbonization step includes one or more liquid organic compounds that are more volatile than water. These may be present in the original feedstock and/or formed during the hydrothermal carbonization step. The bubbles that form during the cavitation-induced size reduction step may in such cases be formed wholly or partially from such organic compounds.

In an especially preferred cavitation-induced size reduction step process, a slurry of the carbonized particles is formed in a liquid phase that includes water. This slurry may be the reaction mixture of either the hydrothermal carbonization step or the liquefaction step, or both. To begin the size reduction process, the slurry is brought to a temperature above 100° C., preferably at least 160° C., more preferably 160-350° C. These temperature conditions often already exist during the hydrothermal carbonization and liquefaction steps, so if the cavitation-induced size reduction step is performed during either of those steps, it is generally unnecessary to adjust the temperature from the operating temperature of those steps. The pressure is above the saturation pressure of at least one component of the liquid phase at the given temperature, such that the component is maintained as a subcooled liquid. Preferably, the pressure is above the saturation pressure of water at the given temperature, such that water is maintained as a subcooled liquid. As before, these pressure conditions already exist during the carbonization and liquefaction steps, so no pressure adjustment is needed to bring the slurry to the necessary conditions for beginning the size reduction process.

The saturation pressure is the minimum pressure needed to force a gas into the liquid (subcooled) state at a given temperature. The saturation pressure for a substance can be determined empirically. For many substances, these pressures are reported in the literature. In the case of water, the saturation pressures are particularly well known, and are reported, for example, in Table 3, “Compressed Water and Superheated Steam” published by National Institute of Standards and Technology (NIST) and found at http://www.nist.gov/srd/upload/NISTIR5078-Tab3.pdf. Saturation pressures for water at various temperatures can be generated using the Engineering Equation Solver (EES) software developed by S. A. Klein and F. L. Alvarado. This software incorporates the Steam IAPWS routine, which in turn incorporates the 1995 Formulation for the Thermodynamic Properties of Ordinary Water Substance for General and Scientific Use, issued by The International Association for the Properties of Water and Steam (IAPWS). The saturation pressures for water at various exemplary temperatures are:

160° C.-618.28 kPa
200° C.-1554.9 kPa
250° C.-3976.2 kPa
300° C.-8587.9 kPa
350° C.-16.529 MPa

In this especially preferred cavitation-induced size reduction process, bubbles are then formed by reducing the pressure to below the saturation pressure of at least one subcooled component of the liquid, preferably to below the saturation pressure of water, at the operating temperature. The pressure may be reduced to, for example 50 to 99%, preferably 75 to 95% of the saturation pressure. It is not necessary to change the temperature, although small changes in temperature may be produced as a result of the pressure drop, and as a result of the vaporization of a portion of the liquid to form bubbles. If the temperature is reduced, the pressure drop is to a value below the saturation pressure at the reduced pressure. Bubbles form with the drop in pressure. It is believed that solid particles in the slurry function as bubble nucleation sites.

Once bubbles have formed, the pressure is again increased to above the saturation pressure of at least one of the components of the liquid phase, preferably water, that has volatilized to form the bubbles. The pressure may be increased to, for example, 100 to 200% of the saturation pressure, preferably 100 to 125% thereof. Again, it is not necessary to adjust the temperature, although the increase in pressure may induce a small temperature increase. The latent heat of vaporization released when the bubbles collapse may contribute to a small temperature rise. Furthermore, the reaction conditions are in general sufficient for hydrothermal carbonization and/or liquefaction to take place; as those reactions are exothermic, the exothermic heat of reaction also may result in a small temperature increase. During the bubble-forming and bubble-collapsing steps, heat may be removed or added to maintain a nearly constant temperature (such as, for example, maintaining the temperature within a range of ±20° C. or less, or of ±10° C. or less) in the liquid phase.

In this especially preferred process, the bubble-forming and collapsing steps can be repeated as just described, by sequentially reducing the pressure and then increasing the pressure below and above the saturation pressure of at least one subcooled component of the liquid phase, and in particular below and above the saturation pressure of water, at the process temperature.

Pressure cycling to induce cavitation can be accomplished through a variety of means, for example by use of a reciprocating piston, a resonating piezoelectric module, a rapidly opening and closing solenoid valve placed at any point in the system, or through the use of a reciprocating feedstock pump. These all can be used to impart compression and expansion waves, achieved through system mass and/or volume fluctuations, into a slurry which is at saturation or near saturation (boiling) conditions. For example, a system to create cavitation-induced size reduction may include a constant pressure source using a nitrogen tank and a regulator to provide pressurized gas at the needed pressures, a pressure sensor that monitors the system pressure, a control unit that interprets the system pressure signal and provides an ON/OFF signal to a high pressure solenoid bleed valve, and a solenoid bleed valve placed along the nitrogen feed line that purges some of the nitrogen to produce a pressure drop. Controlled, pulsed opening of the valve results in sufficiently large system pressure drop to induce bubble formation within the slurry, most likely as attached bubbles or microbubbles to the particles in the slurry or carbonized surfaces (i.e., heterogeneous nucleation sites). Closing the valve results in a pressure increase, which collapses the bubbles.

Further cavitation-induced size reduction may be achieved during the heating cycle of the hydrothermal carbonization or liquefaction step. In this approach, the slurry is at hydrothermal carbonization or liquefaction conditions. Higher temperature steam is injected into the slurry, such as through one or several small orifice(s) or through a perforated pipe over which the carbonized slurry flows, or through orifice(s) in a series of perforated pipes located within the reactants in a reactor, thereby causing intimate contact between the slurry and the pressurized steam. Upon contacting the steam with the slurry, the steam bubbles cool and collapse to impart energy into the surrounding liquid.

In another but less preferred approach, a jet of pressurized hot water is injected at high velocity into a preheated slurry at hydrothermal carbonization or liquefaction conditions such that bubble formation and collapse takes place within the jet.

A further advantage of cavitation-induced size-reduction is that it at least in some cases can increase the rate of reaction by reducing the particle size and de-agglomerating the feedstock and/or carbonized solids, by improving bulk mixing and/or by providing localized heating due to the heat released when the bubbles collapse.

The reduced-in-size carbonized particles are subjected to hydrothermal liquefaction conditions, whereby at least a portion of the carbonized particles are converted to one or more liquid hydrothermal carbonization products. These conditions typically include a temperature of at least 160° C. The temperature preferably is at least 200° C. and may be at least 250° C. The temperature may be as high as 400° C. and preferably is up to 375° C. The pressure conditions are in general above the saturation pressure of water at the temperature of the liquefaction step. More stringent conditions are required for liquefaction than for carbonization; therefore, at least one of the pressure and temperature typically is greater than in the hydrothermal carbonization step. The pressure in the liquefaction step typically is at least 4 MPa and more typically at least 8 MPa. The pressure may be as high as 30 MPa, but preferably is no higher than 20 MPa. These conditions are maintained for a period of time sufficient to produce liquefaction products. Liquid organic material that are not carbonized in the hydrothermal carbonization step, and/or are otherwise present in the reaction mixture, may also react during the hydrothermal liquefaction step.

The liquefaction products are carbon-containing compounds that are liquid at room temperature and one atmosphere pressure. These include various oily compounds that may have molecular weights, for example, from 350 to 3000, especially 500 to 1500, as well as various liquid organic compounds having molecular weights of about 60 to about 350, including, for example, hydrocarbons, alkanols, liquid phenolic compounds, phenolic ethers, benzoic acid and derivatives, liquid furanes, liquid furfurals, and polyfuranes, liquid aldehydes, liquid esters, liquid amine compounds, liquid pyroles, liquid pyridines, and the like. Liquefaction products may be characterized by having an oxygen:carbon atomic ratio of <0.8, <0.6, <0.4, <0.2 or <0.1, a nitrogen:carbon atomic ratio of <0.5, <0.25 or <0.1, and/or a hydrogen:carbon atomic ratio of <1.5, <1.0 or <0.8. Liquefaction products may eventually be used as fuels (such as biodiesel), as renewal solvents or (entirely or partially) as raw materials for manufacturing various chemical compounds.

The hydrothermal liquefaction reaction may also produce one or more reaction products that are gases at room temperature and one atmospheric pressure, such as carbon dioxide, nitrogen, NOₓ compounds, carbon monoxide, methane and water.

General methods for performing hydrothermal liquefaction of organic feedstocks as described, for example, by Kruse et al., Current Opinion in Chemical Biology 2013, 17:515-521; by Zhang in Chapter 10 (pp. 201-232) of Biofuels from Agricultural Wastes and Byproducts, Hans P. Blaschek et al., eds., Blackwell Publishing 2010; and US Published Patent Application No. 2012-0110896 are suitable for performing the first hydrothermal carbonization and liquefaction steps of this invention. The hydrothermal liquefaction step may be performed using a method as described in US Published Patent Application No. 2015-0361372 (incorporated herein by reference). In such a process, the slurry of carbonized particles is mixed under elevated pressure with a steam stream under conditions such that upon mixing all or a portion of the steam condenses and a reaction mixture having a temperature of at least 160° C. is formed at a pressure of at least 8 MPa.

As with the hydrothermal carbonization step, the particular equipment used to perform the hydrothermal liquefaction is not critical, so long as it can tolerate the necessary temperatures and pressures. Batch, semi-batch, semi-continuous or continuous equipment can be used. If desired, the same equipment can be used to perform both the hydrothermal carbonization step and the hydrothermal liquefaction step.

In some embodiments of the invention, the hydrothermal carbonization step, the particle size reduction step and the hydrothermal liquefaction step are all performed sequentially.

In other embodiments, all or part of the particle size reduction step can be performed during the hydrothermal carbonization step, so that at least some of the production of carbonized particles and some of the size reduction occurs at the same time. This can be done, for example, by performing the hydrothermal carbonization step in apparatus adapted for performing size reduction. For example, the apparatus can include a rotor stator, other mechanical grinding means, and/or be adapted for cavitation-induced size reduction through means to vary pressure and/or temperature as described above. Size reduction can be performed ultrasonically, as well.

Similarly, all or part of the particle size reduction step can be performed during all or part of the hydrothermal liquefaction step. This can be done by performing the hydrothermal liquefaction step in apparatus adapted for performing size reduction, such as described in the preceding paragraph.

With suitably designed apparatus, the hydrothermal carbonization step, the particle size reduction step and the hydrothermal liquefaction step all can be performed in the same apparatus. Such an apparatus is capable of withstanding the temperatures and pressures of the hydrothermal liquefaction step (which are generally more severe than those of the hydrothermal carbonization step), and in addition is adapted for performing the size reduction, as described before. The hydrothermal carbonization step, size reduction step and hydrothermal liquefaction step can be performed sequentially in such apparatus, or the particle size reduction step can be partially or fully performed during part or all of either or both of the hydrothermal carbonization and hydrothermal liquefaction steps. A schematic of a suitable apparatus is shown in FIG. 2.

Turning to FIG. 1, there is shown a schematic diagram of an apparatus for performing the process of the invention. Apparatus 1 includes first vessel 2. The organic feedstock is fed to first vessel 2 through line 4. The organic feedstock may be formed into a slurry and fed to first vessel 2 as a slurry. Alternatively, the liquid phase may be introduced into first vessel 2 separately and the slurry formed inside of first vessel 2. The slurry within first vessel 2 is indicated by reference numeral 3.

In the embodiment shown in FIG. 1, steam is introduced into first vessel 2 through line 5. This is an optional but preferred feature, which allows slurry 3 to be heated by steam provided through line 5. In the embodiment shown, a pressurizing gas is provided to first vessel 2 through line 7. If steam is to be fed into first vessel 2 through line 5, it may be unnecessary to provide pressurizing gas through line 7. Line 9 provides a means for removing gas from the inside of first vessel 2.

The hydrothermal carbonization step is performed in first vessel 2. Slurry 3 is brought to a temperature and pressure as indicated before, sufficient to effect the hydrothermal carbonization of the feedstock to at least partially carbonize the feedstock. Pressure can be controlled in several ways such as, for example, by pressurizing the interior of first vessel 2 with steam provided through line 5, by pressurizing the interior of first vessel 2 with a pressurizing gas provided by line 7, and/or by removing gas through outlet line 9. As shown, each of lines 5, 7 and 9 are equipped with optional pressure regulators 6, 8 and 10 for controlling pressure to the desired level.

Heating and/or cooling can be provided by jacketing first vessel 2. Slurry 3 can be heated within first vessel 2, and/or it or its components can be partially or fully heated before being charged to first vessel 2. In certain embodiments, slurry 3 is heated to a temperature of up to 100° C. and then combined with steam provided through line 5 under pressure conditions such that at least some of the steam condenses to form subcooled water. In this way, the latent heat of vaporization goes to increase the temperature of the slurry. This step of mixing a preheated slurry with steam can alternatively be performed outside of first vessel 2, and the heated, pressurized slurry so formed then transferred to first vessel 2.

In the embodiment shown, first vessel 2 is equipped with agitation means 11, to help prevent settling of the feedstock particles and carbonized particles as they form. Agitation means 11 can be one or more agitators or other mechanical mixing devices, and/or may be or include one or more static mixing elements. Agitation can be performed by sparging the slurry with an inert gas such as nitrogen.

In the embodiment shown in FIG. 1, at least partially carbonized solids are withdrawn from first vessel 2 through line 12 and transferred to size reduction apparatus 13, which can be of any suitable design, including those mentioned above. It is generally preferred to withdraw a slurry from first vessel 2, in which case the solid and liquid phases of the slurry can be partially or entirely separated before the carbonized material is transferred to size reduction apparatus 13. Size reduction apparatus preferably is capable of handling a slurry and performing size reduction on solids dispersed in a slurry, so a separation step can be avoided.

The reduced-in-size particles formed in size reduction apparatus 13 are transferred to second vessel 15 through line 14. If desired, a size segregation step can be performed, so larger particles are separated from the smaller particles taken to second vessel 15. These larger particles can be recycled back into first vessel 2 and subjected to further hydrothermal carbonization.

In the embodiment shown in FIG. 1, the hydrothermal liquefaction step is performed in second vessel 15. As shown, the design and operation of second vessel 15 is generally the same as for first vessel 2. A slurry 16 of the carbonized solids in a liquid is formed in second vessel 15. If the slurry from first vessel 2 is passed through size reduction apparatus 13 and then to second vessel 15, it may not be necessary to provide more liquid. If more liquid phase is needed, it can be combined with the at least partially carbonized particles before or after it is introduced into second vessel 15. In an alternative embodiment, the carbonized particles are at least partially separated from the aqueous phase after being removed from first vessel 2 and before being transferred to size reduction apparatus 13, and some or all of the liquid phase that is removed is re-combined with the carbonized particles that exit size reduction apparatus 13.

As shown, steam is introduced into second vessel 15 through line 17. As before, this is an optional but preferred feature, which allows slurry 16 to be heated by steam provided through line 17. In the embodiment shown, a pressurizing gas is provided to second vessel 15 through line 19. If steam is to be fed into second vessel 15 through line 17, it may be unnecessary to provide pressurizing gas through line 19. Line 21 provides a means for removing gas from the inside of second vessel 15, e.g., for pressure regulation or for sampling.

Slurry 16 is brought to a temperature and pressure as indicated before, sufficient to effect the hydrothermal liquefaction of the carbonized particles to form liquid hydrothermal liquefaction processes. Pressure can be controlled in ways analogous to those described with respect to first vessel 2; such as by pressurizing the interior of second vessel 15 with steam provided through line 17, by pressurizing the interior of second vessel 15 with a pressurizing gas provided by line 19, and/or by removing gas through outlet line 21. As shown, each of lines 17, 19 and 21 are equipped with optional pressure regulators 18, 20 and 22 for controlling pressure to the desired level.

Also as before, heating and/or cooling can be provided by jacketing second vessel 15. Slurry 16 can be heated to the reaction temperature within second vessel 15, and/or can be partially or fully heated beforehand. In certain embodiments, slurry 16 is heated to a temperature of up to 100° C. and then combined with steam provided through line 17 under pressure conditions such that at least some of the steam condenses to form subcooled water. In this way, the latent heat of vaporization goes to increase the temperature of the slurry. This step of mixing a preheated slurry with steam can alternatively be performed outside of second vessel 15, and the heated, pressurized slurry so formed then transferred to second vessel 15.

Second vessel 15 may be equipped with optional agitation means 23, similar to as described with regard to first vessel 2.

Product is removed from second vessel 15 through line 24.

The apparatus shown in FIG. 1 is adaptable for batch, semi-continuous or continuous operation. In continuous mode, plug flow conditions can be established through each of first vessel 2, size reduction apparatus 13 and second vessel 15, with continuous addition of starting materials into first vessel 2 and continuous withdrawal of product from second vessel 15. In semi-continuous mode, plug flow conditions again can be established, with intermittent introduction of starting materials into first vessel 2 and intermittent removal of product from second vessel 15.

The apparatus shown in FIG. 2 is a simplified apparatus 51, which permits each of the hydrothermal carbonization, particle size reduction and hydrothermal liquefaction steps to be performed in a single vessel 52. As before, it may be formed into a slurry before being introduced into vessel 52.

As shown in FIG. 2, steam is introduced into vessel 52 through line 55. This is an optional but preferred feature, which allows slurry 53 to be heated by steam provided through line 55. In the embodiment shown, a pressurizing gas is provided to vessel 52 through line 58. If steam is to be fed into vessel 52 through line 55, it may be unnecessary to provide pressurizing gas through line 58. Line 59 provides a means for removing gas from the inside of vessel 52. Feedstock is provided to vessel 52 through line 54.

Pressure within vessel 52 can be controlled generally as described with respect to FIG. 1; for example by pressurizing the interior of vessel 52 with steam provided through line 55, by pressurizing the interior of first vessel 52 with a pressurizing gas provided by line 58, and/or by removing gas through outlet line 59, or by other equivalent means. As shown, each of lines 54, 55, 58 and 59 are equipped with optional pressure regulators 54A, 56, 57 and 60 for controlling pressure to the desired level.

Heating and/or cooling can be provided by jacketing vessel 52, as before. Slurry 53 can be heated within vessel 52, and/or can be partially or fully heated beforehand. In certain embodiments, slurry 53 is heated to a temperature of up to 100° C. and then combined with steam provided through line 55 under pressure conditions such that at least some of the steam condenses to form subcooled water. In this way, the latent heat of vaporization goes to increase the temperature of the slurry. This step of mixing a preheated slurry with steam can alternatively be performed outside of vessel 52, and the heated, pressurized slurry so formed then transferred to vessel 52.

In the embodiment shown, vessel 52 is equipped with agitation means 61, as before. A product outlet such as outlet line 62 can be provided to remove liquid and/or solid reaction products from vessel 52.

The hydrothermal carbonization and the subsequent hydrothermal liquefaction steps are performed sequentially in vessel 52. The hydrothermal carbonization step is performed at temperature and pressure conditions as described above, sufficient to carbonize some or all of the feedstock. Thereafter, the operating pressure and optionally the operating temperature as well are adjusted as necessary to establish conditions sufficient to perform the hydrothermal liquefaction step. In such embodiments, the particle reduction step can be performed 1) as a separate intermediate step, under conditions insufficient to achieve either hydrothermal carbonization to a carbonized solid or hydrothermal liquefaction; 2) simultaneously with at least a portion of the hydrothermal carbonization step, 3) simultaneously with at least a portion of the hydrothermal liquefaction step, or 4) any combination of two or more of 1), 2) or 3).

A highly preferred method of performing the size reduction step in an apparatus as shown in FIG. 2 is an cavitation-induced size reduction method as described before. Bubbles are formed and then collapsed, preferably by fluctuating the pressure within vessel 52, for example through feeding and/or removing gas through any of lines 55, 58 and 59, or equivalent means. This can be done during either or both of the hydrothermal carbonization or hydrothermal liquefaction steps, and/or as a separate step interposed between the hydrothermal carbonization and the hydrothermal liquefaction step.

What is claimed is:

1. A hydrothermal liquefaction process comprising the steps of
a) combining a particulate solid organic feedstock with water to form an aqueous slurry;
b) subjecting the aqueous slurry to hydrothermal carbonization conditions including a temperature of at least 160° C. and a superatmospheric pressure sufficient to maintain water as a subcooled liquid, to at least partially carbonize the feedstock and form at least partially carbonized solids, then
c) reducing the size of the at least partially carbonized solids to produce reduced-size carbonized particles; and
d) subjecting the reduced-size carbonized particles to hydrothermal liquefaction conditions in the presence of subcooled water, steam or a mixture of subcooled water and steam to convert at least a portion of the reduced-size carbonized particles to one or more liquid hydrothermal liquefaction products.

2. The process of claim 1, wherein in step c), carbonized particles form having surface areas of 0.03 cm² or less.

3. The process of claim 1, wherein in step c), the at least partially carbonized solids are reduced in size mechanically or ultrasonically.

4. The process of claim 1, wherein in step c), the at least partially carbonized solids are reduced in size using a cavitation-induced size reduction method.

5. The process of claim 4, wherein the cavitation-induced size reduction method includes cycling a slurry of the at least partially carbonized solids through one or more bubble forming and bubble collapsing cycles whereby the at least partially carbonized solids are reduced in size, wherein each bubble forming and bubble collapsing cycle includes the steps of i) adjusting the pressure and/or temperature of the intermediate slurry such that a portion of the liquid phase volatilizes to form bubbles and then ii) re-adjusting the pressure and/or temperature to collapse the bubbles.

6. The process of claim 4 wherein the cavitation-induced size reduction method is performed on a slurry of the at least partially carbonized solids in a liquid phase that includes at least one subcooled compound, establishing an operating temperature of at least 160° C. and a pressure above the saturation pressure of the at least one subcooled compound, forming bubbles that include the at least one subcooled compound by reducing the pressure to below the saturation pressure of the at least one subcooled compound at the operating temperature such that a portion of the at least one subcooled compound volatilizes, and collapsing the bubbles by then increasing the pressure to above the saturation pressure of the at least one subcooled compound.

7. The process of claim 4 wherein the cavitation-induced size reduction method is performed on a slurry of the at least partially carbonized solids in a liquid phase that includes water, establishing an operating temperature of at least 160° C. and a pressure above the saturation pressure of water, forming bubbles that include water by reducing the pressure to below the saturation pressure of water at the operating temperature such that a portion of the water volatilizes, and collapsing the bubbles by then increasing the pressure to above the saturation pressure of water.

8. The process of any claim 1, wherein at least a portion of step c) is performed during at least a portion of step b).

9. The process of claim 1, wherein at least a portion of step c) is performed during at least a portion of step d).

10. The process of any claim 1, wherein steps b), c) and d) are performed in a single vessel.

11. The process of claim 1, wherein the hydrothermal carbonization conditions include a temperature of 160 to 250° C. and a pressure above the saturation temperature of water at the temperature.

12. The process of claim 1, wherein the hydrothermal liquefaction conditions include a temperature of 250 to 400° C. and a pressure above the saturation temperature of water at the temperature.
